(19) United States
(12) Patent Application Publication
(10) Pub. No.: US 2014/0054266 A1
(43) Pub. Date: Feb. 27, 2014

(54) COMPOSITIONS AND METHODS FOR SELECTIVE POLISHING OF PLATINUM AND RUTHENIUM MATERIALS

(71) Applicants: Wiechang JIN, Madison, WI (US); Elizabeth REMSEN, Oswego, IL (US)

(72) Inventors: Wiechang JIN, Madison, WI (US); Elizabeth REMSEN, Oswego, IL (US)

(21) Appl. No.: 13/593,634

(22) Filed: Aug. 24, 2012

(51) Int. Cl. C23F 1/40; C09K 13/00; C23F 1/14

(52) U.S. Cl. 216/53; 252/79.1

(57) ABSTRACT

The present invention provides chemical-mechanical polishing (CMP) methods for polishing a platinum and/or ruthenium containing substrate, and compositions suitable for use in the methods. The polishing compositions used with the methods of the invention, which contain alumina and at least one additive selected from the group consisting of a suppressor, a complexing agent, and an amino compound, allow for platinum and ruthenium to be polished. The methods of the invention provide for tailoring the relative removal rates of platinum, ruthenium, silicon oxide and silicon nitride.

### FIELD OF THE INVENTION

This invention relates to polishing compositions and methods. More particularly, this invention relates to methods for polishing platinum-containing and ruthenium-containing substrates and compositions therefor.

### BACKGROUND OF THE INVENTION

Typical solid state memory devices (dynamic random access memory (DRAM), static random access memory (SRAM), erasable programmable read only memory (EPROM), and electrically erasable programmable read only memory (EEPROM)) employ micro-electronic circuit elements for each memory bit in memory applications. For typical non-volatile memory elements (like EEPROM, i.e., “flash” memory), floating gate field effect transistors are employed as the data storage device. These devices hold a charge on the gate of the field effect transistor to store each memory bit and have limited re-programmability. They are also slow to program.

FRAM or FeRAM (Ferroelectic Random Access Memory) devices are non-volatile memory devices that are becoming increasingly popular for certain applications. FRAMS are advantageous over certain other memory devices due to high write speeds, low power consumption during write, and high maximum-number of write-erase cycles that can be tolerated by the device.

FRAM devices are similar in construction to DRAM devices, but use a ferroelectric layer instead of a dielectric layer to achieve non-volatility. The dielectric constant of a ferroelectric is typically much higher than that of a linear dielectric material. Typical ferroelectric materials used in FRAM devices include lead zirconate titanate (PZT). Ferroelectric layers are corrosive to silicon, so a platinum (Pt) barrier typically is placed between the ferroelectric layer and the silicon. Electrodeposited Pt is also used for the lower electrode of FRAM devices.

Other noble metals such as ruthenium (Ru) are utilized in fabricating high performance semiconductor devices and capacitors, such as in dynamic random access memory (DRAM) devices.

During semiconductor and memory device manufacture, various layers of materials must be removed or reduced in order to form the various components of the circuits on the wafer, which typically is achieved by chemical-mechanical polishing (CMP). The Pt layer of a FRAM device must be polished during the manufacturing process. Due to the relatively low oxidation rate of Pt, the removal rate of Pt is low relative to certain other materials used to construct memory devices and semiconductors. Pt is generally considered to be a difficult material to polish or remove during semiconductor manufacturing processes.

The Ru layer of DRAM devices must also be polished during the manufacturing process. Due, at least in part, to the high degree of chemical inertness and strong response to mechanical abrasion exhibited by ruthenium barrier layers, current ruthenium polishing compositions typically rely on relatively hard abrasives and strong oxidizing agents to provide adequate ruthenium removal rates. Typically, relatively weak oxidants such as hydrogen peroxide are not very efficient in ruthenium polishing processes, requiring long polishing times and a high polishing pressure in order to adequately planarize the ruthenium.

Compositions and methods for CMP of the surface of a substrate are well known in the art. Polishing compositions (also known as polishing slurries, CMP slurries, and CMP compositions) for CMP of surfaces of semiconductor substrates (e.g., for integrated circuit manufacture) typically contain an abrasive, various additive compounds, and the like.

In conventional CMP techniques, a substrate carrier or polishing head is mounted on a carrier assembly and positioned in contact with a polishing pad in a CMP apparatus. The carrier assembly provides a controllable pressure to the substrate, urging the substrate against the polishing pad. The pad and carrier, with its attached substrate, are moved relative to one another. The relative movement of the pad and substrate serves to abrade the surface of the substrate to remove a portion of the material from the substrate surface, thereby polishing the substrate. The polishing of the substrate surface typically is further aided by the chemical activity of the polishing composition (e.g., by oxidizing agents, acids, bases, or other additives present in the CMP composition) and/or the mechanical activity of an abrasive suspended in the polishing composition. Typical abrasive materials include silicon dioxide, cerium oxide, aluminum oxide, zirconium oxide, and tin oxide.

Although known CMP slurry compositions and polishing pad materials typically are suitable for limited purposes, many conventional compositions and methods exhibit unacceptable polishing rates for removal of Pt and Ru layers. In addition, many known polishing slurries and methods exhibit other poor Pt and Ru layer removal traits and produce undesirable Pt and Ru surface defects such as scratching, pitting, and corrosion.

Conventional CMP compositions and techniques are generally designed to remove a layer such as Pt and Ru while avoiding or minimizing the removal of other material such as silicon nitride (Si₃N₄) or silicon dioxide (SiO₂). These traditional polishing slurries have been designed for “stop on silicon nitride” or “stop on silicon oxide” applications. The ratio of the removal rates of a Pt layer to the removal rate of a base layer is referred to herein as the “selectivity” or “removal rate ratio” for removal of Pt in relation to the other layer during CMP processing. The ratio of the removal rates of a Ru layer to the removal rate of a base layer is referred to herein as the “selectivity” or “removal rate ratio” for removal of Ru in relation to the other layer during CMP processing.

There is an ongoing need to develop new polishing methods that provide relatively high rates of removal of Pt and Ru metal and selective removal of Pt and Ru metal in preference to silicon dioxide (e.g., plasma-enhanced tetraethylorthosilicate-derived silicon dioxide, also known as “PETEOS” or “TEOS”) and silicon nitride. There is also an ongoing need to develop new polishing methods for polishing Pt and Ru metal layers that result in a smooth Pt or Ru surface with reduced surface imperfections such as scratches. The present invention addresses these ongoing needs.

### BRIEF SUMMARY OF THE INVENTION

Chemical-mechanical polishing (CMP) compositions and methods for polishing a platinum (Pt)-containing substrate and/or a ruthenium (Ru)-containing substrate are described. A method embodiment described herein comprises contacting a substrate with a surface of a polishing pad in the presence of an oxidizing agent and an aqueous polishing composition. The polishing composition comprises an aqueous carrier fluid containing a particulate alumina abrasive and at least one additive selected from the group consisting of a suppressor, a complexing agent, and an amino compound. In some embodiments, all three types of additives (suppressor, complexing agent, and amino compound) are present in the composition. In some embodiments, the additive is present in the compositions described herein at a concentration in the range of about 0.001 to about 5 percent by weight.

In some embodiments, the polishing pad has a surface hardness of not more than about 80 Shore D, preferably in the range of about 15 to about 80 Shore D, and more preferably in the range of about 15 to about 50 Shore D. In a preferred embodiment, the surface of the polishing pad is a porous polymer. More preferably, the surface of the polishing pad is a non-woven porous polymer having a hardness in the range of about 15 to 80 Shore D and having a percentage open pore volume in the range of about 10% to about 60%. In some preferred embodiments, the pad is constructed from a porous polyurethane.

Preferably, the alumina is present in the composition at a concentration in the range of about 0.001 to about 10 percent by weight (wt %). Also preferably, the alumina has an average particle size in the range of about 10 to about 1000 nm.

In some embodiments, the additive comprises, consists essentially of, or consists of a suppressor. The suppressor reduces the oxide rate, and in some cases increases selectivity for removal of Pt and Ru. Non-limiting examples of a suppressor suitable for use in the compositions and methods described herein include water soluble carbohydrates (e.g., a sugar such as sucrose, or a polysaccharide such as 2-hydroxyethyl cellulose or dextrin). The suppressor, when utilized, preferably is present in the composition at a concentration in the range of about 0.001 to about 1 wt %, for example.

In some embodiments, the additive comprises, consists essentially of, or consists of a complexing agent. The complexing agent promotes the polishing of metals, and in some cases increases the removal rate of metals. Non-limiting examples of complexing agents suitable for use in the compositions and methods described herein include alkanolamines such as monoethanolamine, diethanolamine, triethanolamine, triethylamine, propanolamine, butanolamine, bis(2-hydroxyethyl)amino-tris(hydroxymethyl)methane and the like. Further examples of complexing agents include acetate and carboxylic acid (carboxylate) salts including potassium acetate, ammonium acetate, acetic acid and the like. The complexing agent, when utilized, preferably is present in the composition at a concentration in the range of about 0.001 to about 5 wt %, for example.

In some embodiments, the additive comprises, consists essentially of, or consists of an amino compound. The amino compound is used to adjust the ionic strength of the composition, which in some cases improves the selectivity of the composition by helping increase the metal polishing rate or decrease the oxidation rate. Non-limiting examples of amino compounds suitable for use in the compositions and methods described herein include ammonia, primary amines, secondary amines, tertiary amines, ammonium salts (e.g., ammonium chloride, ammonium acetate, triethylammonium acetate, and the like); and quaternary ammonium salts (e.g., tetramethylammonium salts, tetrabutylammonium salts, and the like). The amino compound, when utilized, preferably is present in the composition at a concentration in the range of about 0.001 to about 5 wt %, for example.

The polishing composition used in the methods described herein also can contain an oxidizing agent. In some embodiments, the oxidizing agent comprises, consists essentially of, or consists of hydrogen peroxide. In a preferred embodiment, the oxidizing agent is present in the composition at a concentration in the range of about 0.1 to about 10 wt % at point of use (i.e. diluted for direct use in a CMP procedure). In some embodiments the oxidizing agent is added to the composition just prior to polishing the substrate (e.g., within a few minutes to a few days prior to polishing a substrate).

Preferably, the polishing composition used in the method described herein has a pH in the range of about 4 to about 8 (e.g., about 5 to 7). Various buffering agents can be included in the compositions to achieve the desired composition pH.

In some embodiments, the present invention provides a chemical-mechanical polishing method suitable for polishing a substrate comprising platinum or ruthenium or both. The method comprises contacting a substrate with a surface of a polishing pad in the presence of an oxidizing agent and an aqueous polishing composition between the pad and the substrate. The polishing composition preferably has a pH in the range of about 4 to about 8 and comprises an aqueous carrier containing a particulate alumina abrasive and at least one of a suppressor, a complexing agent, and an amino compound.

The oxidizing agent used in some embodiments of the methods and compositions described comprises hydrogen peroxide. Preferably, the oxidizing agent is present in the composition at a concentration in the range of about 0.1 to about 10 percent by weight (wt %).

The suppressor used in some embodiments of the methods and compositions described herein is a water-soluble carbohydrate, preferably sucrose.

In some embodiments, the complexing agent used in the methods and compositions described herein comprises an alkanolamine (e.g., bis(2-hydroxyethyl)amino-tris(hydroxymethyl)methane, a carboxylate salt, or a combination thereof. Preferably, the carboxylate salt is present in the composition at a concentration in the range of about 0.01 to about 1.5 percent by weight.

Any suitable polishing pad can be utilized and the methods described herein. In some embodiments, the polishing pad has a hardness of not more than about 80 Shore D. The surface of the polishing pad contacting the substrate preferably comprises a porous polymer, such as, for example, a non-woven porous polyurethane having a hardness in the range of about 15 to 80 Shore D, and more preferably in the range of about 15 to about to about 50 Shore D. In some embodiments, the surface of the polishing pad comprises a non-woven porous polymer having a percentage open pore volume in the range of about 10 to 80%.

In another aspect, the present invention provides a chemical-mechanical polishing method of contacting a substrate with a surface of a polishing pad in the presence of an oxidizing agent and an aqueous polishing composition. The surface of the polishing pad has a hardness of not more than about 80 Shore D, and the polishing composition has a pH in the range of about 5 to about 7. The aqueous carrier comprises about 0.001 to about 10 percent by weight of a particulate alumina abrasive having an average particle size in the range of about 10 to about 1000 nm, and, optionally, about 0.1 to about 10 wt % of hydrogen peroxide, a suppressor, a complexing agent, and an amino compound.

In another embodiment, the present invention provides an aqueous polishing composition suitable for polishing a platinum-containing or ruthenium-containing surface. The polishing composition has a pH of about 4 to about 8 and an aqueous carrier containing about 0.001 to about 10 by weight of a particulate alumina abrasive and about 0.001 to about 5 percent by weight of at least one of a suppressor, a complexing agent, and an amino compound.

Some embodiments of the CMP compositions and methods described herein provide an unexpectedly high platinum metal removal rate and selectivity for platinum removal compared to silicon dioxide and silicon nitride removal when a relatively soft polishing pad is utilized, as described herein. Typically, in such embodiments, the platinum removal rate obtained during polishing of a semiconductor wafer according to the methodology described herein exceeds the silicon dioxide removal rate by a factor of about 2 or more, more typically by a factor of about 3 or more. The CMP compositions and methods described herein also provide an unexpectedly high ruthenium removal rate, as well.

### BRIEF DESCRIPTION OF THE DRAWINGS

FIG. 1 provides a graph of removal rate (RR) for platinum (Pt) and silicon oxide (TEOS), obtained by polishing blanket wafers using the methods described herein with compositions containing varying levels of alumina.

### DETAILED DESCRIPTION OF THE INVENTION

The present invention provides methods and compositions for polishing a substrate comprising platinum, ruthenium, or a combination thereof. In a preferred embodiment, a method described herein comprises contacting the substrate with a surface of a polishing pad in the presence of an aqueous polishing composition between the pad and the substrate. The CMP compositions described herein comprise, consist essentially of, or consist of an aqueous carrier fluid containing a particulate alumina abrasive and at least one additive selected from the group consisting of a suppressor, a complexing agent, and an amino compound, as described herein.

In some preferred embodiments, suitable polishing pads preferably have a hardness of less than about 80 Shore D. More preferably, the polishing pad has a hardness in the range of about 15 to about 80 Shore D. In some preferred, soft-pad embodiments, the polishing pad has a Shore D hardness in the range of about 15 to 50 Shore D. The pad can be constructed of composed of any material, including solid, foam, woven or non-woven materials, which will provide a polishing pad of the desired hardness. The pad can include grooves if desired. Suitable polymeric materials for forming the pad include, for example, polyvinylchloride, polyvinylfluoride, nylon, fluorocarbon, polycarbonate, polyester, polyacrylate, polyether, polyethylene, polyamide, polyurethane, polystyrene, polypropylene, co-formed products thereof, and mixtures thereof, which are formulated and constructed to have the desired hardness. In some preferred embodiments, the polishing surface of the pad is formed from a porous polyurethane.

Advantageously, some embodiments of the methods described herein use a polishing pad having a relatively soft surface compared with polishing pads used in other Pt CMP methods and Ru CMP methods known in the art. Because of the difficulty in removing Pt and Ru layers with CMP, Pt and Ru CMP methods known in the art generally use polishing pads having a relatively “hard” surface. Using such pads with “hard” surfaces can result in undesirable defects on the surface of the platinum, such as micro scratches. The properties of the compositions described herein and discussed further below unexpectedly allow for a “softer” polishing pad to be used to polish a platinum-containing substrate.

In one preferred embodiment, the polishing pad used in the method described herein comprises a relatively soft, non-woven porous polymer (e.g., polyurethane) having a durometer hardness in the range of about 15 to 50 Shore D, preferably having a percentage open pore volume in the range of about 10 to 80%, more preferably about 45 to 80%, such as the polishing pad commercially available from Rohm and Haas under the tradename POLITEX, as well as the BLACKCHEM 2 pad available from Nanofinish Corporation which has properties similar to the POLITEX pad. The pad available from Cabot Microelectronics Corporation under the tradename EPIC D200 42D (having hardness of about 42 Shore D) is another example of a relatively soft polishing pad appropriate for use with the methods described herein. The use of the relatively soft pad in the methods described herein provides for removal of platinum in preference to silicon oxide (e.g. TEOS).

In some embodiments described herein, a relatively harder polishing pad having a hardness of up to about 80 Shore D can be utilized, if desired. For example, an EPIC D100 polishing pad having a surface hardness in the range of about 72 Shore D can be used in conjunction with a composition containing specific components such as ammonium acetate.

The particulate alumina abrasive can be present in the polishing composition at a concentration in the range of about 0.001 to about 10 wt %. Preferably, the alumina is present in the CMP composition at a concentration in the range of about 0.01 to about 3 wt %. At point of use, the alumina abrasive preferably is present at a concentration of about 0.01 to about 2 wt %, more preferably about 0.05 to about 1 wt %. The abrasive particles preferably have a mean particle size in the range of about 10 nm to about 1000 nm, more preferably about 50 nm to about 250 nm, as determined, e.g., by laser light scattering techniques, which are well known in the art.

The alumina abrasive desirably is suspended in the polishing composition, more specifically in the aqueous carrier component of the polishing composition. When the abrasive is suspended in the polishing composition, it preferably is colloidally stable. The term “colloid” refers to the suspension of abrasive particles in the liquid carrier. “Colloidal stability” refers to the maintenance of that suspension over time. In the context of the methods and compositions described herein, an alumina suspension is considered colloidally stable if, when the alumina suspension is placed into a 100 mL graduated cylinder and allowed to stand without agitation for a time of 2 hours, the difference between the concentration of particles in the bottom 50 mL of the graduated cylinder ([B] in terms of g/mL) and the concentration of particles in the top 50 mL of the graduated cylinder ([T] in terms of g/mL) divided by the total concentration of particles in the abrasive composition ([C] in terms of g/mL) is less than or equal to 0.5 (i.e., ([B]−[T])/[C]≦0.5). The value of ([B]−[T])/[C] desirably is less than or equal to 0.3, and preferably is less than or equal to 0.1.

In some embodiments, the suppressor additive of the CMP compositions used in the methods described herein can be, for example, a sugar (e.g., sucrose), or a polysaccharide (e.g., 2-hydroxyethyl cellulose or dextrin). The suppressor can be present in the polishing composition at a concentration in the range of about 0.001 to about 10 wt %. Preferably, the suppressor is present in the CMP composition at a concentration in the range of about 0.01 to about 1 wt %.

In some embodiments, the complexing agent additive of the CMP compositions used in the methods described herein can be, for example, an alkanolamine such as monoethanolamine, diethanolamine, triethanolamine, triethylamine, propanolamine, butanolamine, bis(2-hydroxyethyl)amino-tris(hydroxymethyl)methane and the like. In addition, or alternatively, the complexing agent additive can be, for example, a carboxylic acid salts such as potassium acetate, ammonium acetate, and the like. Other non-limiting examples of complexing agents include histidine, lysine, glycine, picolinic acid, tartaric acid, iminodiacetic acid, alanine, benzoic acid, nitrilotriacetic acid (NTA), glutamic acid, glutaric acid, beta-alanine, aspartic acid, ornithine, and proline. The alkanolamine, when utilized, can be present in the composition at a concentration in the range of about 0.001 to about 5%. Preferably, the carboxylate salts, when utilized, are included in the composition at a concentration in the range of about 0.01 to about 5 wt %, more preferably about 0.01 to about 1.5 wt %.

The amino compound additive of the CMP compositions and methods described herein can be, for example, ammonia, an organic amine, an ammonium salt or a combination thereof. Non-limiting examples of amino compounds suitable for use in the compositions and methods described herein include a primary amine, a secondary amine, a tertiary amine, ammonium chloride, ammonium acetate, triethylammonium acetate, and the like. Non-limiting examples of tertiary amines suitable include trimethylamine, triethanolamine, triethylamine, tripropylamine, diisopropylethylamine, and the like. In some embodiments, the amino compound additive of the CMP compositions used in the methods described herein can be, for example, a quaternary ammonium salt, e.g., a tetraalkylammonium salt (e.g., tetramethylammonium chloride, tetramethylammonium nitrate, tetramethylammonium sulfate or tetramethylammonium acetate), a tetrabutylammonium salt (e.g., tetrabutylammonium chloride, tetrabutylammonium nitrate, tetrabutylammonium sulfate or tetrabutylammonium acetate) and the like. A combination of two or more ammonium salts may also be used in the compositions used in the methods described herein.

The amino compound or compounds can be included in the composition at a concentration in the range of about 0.001 to about 5 wt %, for example. In some embodiments, the amino compound is present in the CMP composition at a concentration in the range of about 0.01 to about 1 wt %.

In some embodiments, the polishing composition includes one or more oxidizing agents. Oxidizing agents suitable for use in the polishing compositions and methods described herein include, without limitation hydrogen peroxide, persulfate salts (e.g., ammonium monopersulfate, ammonium dipersulfate, potassium monopersulfate, and potassium dipersulfate), periodate salts (e.g., potassium periodate), salts thereof, and a combination of two or more of the foregoing. Preferably, the oxidizing agent is present in the composition in an amount sufficient to oxidize one or more selected metallic or semiconductor material present in the semiconductor wafer, as is well known in the semiconductor CMP art.

Preferably, the oxidizing agent in the compositions of the present invention is hydrogen peroxide. The oxidizing agent can be present in the polishing composition at a concentration in the range of about 0.1 to about 10 wt % at point of use. As used herein, a concentration at point of use means the concentration actually used to contact the substrate during polishing. Preferably, the oxidizing agent is present in the CMP composition at a concentration in the range of about 0.5 to about 5 wt %. Preferably, the oxidizing agent is added to the composition just prior to use (i.e., a few days to a few minutes prior to use).

The compositions described herein preferably have a pH in the range of about 4 to about 8, more preferably about 5 to about 7. The pH of the composition can be achieved and/or maintained by inclusion of a buffering material including an acidic component, which can be any inorganic or organic acid. In some preferred embodiments, the acidic component can be an inorganic acid, a carboxylic acid, an organophosphonic acid, an acidic heterocyclic compound, a salt thereof, or a combination of two or more of the foregoing. Non-limiting examples of suitable inorganic acids include hydrochloric acid, sulfuric acid, phosphoric acid, phosphorous acid, pyrophosphoric acid, sulfurous acid, and tetraboric acid, or any acidic salt thereof. Non-limiting examples of suitable carboxylic acids include, monocarboxylic acids (e.g., acetic acid, benzoic acid, phenylacetic acid, 1-naphthoic acid, 2-naphthoic acid, glycolic acid, formic acid, lactic acid, mandelic acid, and the like), and polycarboxylic acids (e.g., oxalic acid, malonic acid, succinic acid, adipic acid, tartaric acid, citric acid, maleic acid, fumaric acid, aspartic acid, glutamic acid, phthalic acid, isophthalic acid, terephthalic acid, 1,2,3,4-butanetetracarboxylic acid, itaconic acid, and the like), or any acidic salt thereof. Non-limiting examples of suitable organic phosphonic acids include phosphonoacetic acid, iminodi(methylphosphonic acid), DEQUEST 2000LC brand amino-tri(methylenephosphonic acid), and DEQUEST 2010 brand hydroxyethylidene-1,1-diphosphonic acid, both of which are available from Solutia, or any acidic salt thereof. Non-limiting examples of suitable acidic heterocyclic compounds include uric acid, ascorbic acid, and the like, or any acidic salt thereof.

The polishing compositions described herein can also optionally include suitable concentrations of one or more other additive materials commonly included in polishing compositions, such as corrosion inhibitors, viscosity modifying agents, biocides, and the like.

Non-limiting examples of biocides include KATHON brand methylchloroisothiazolinone, as well as NEOLONE brand methylisothiazolinone, both available from Rohm and Haas. Non-limiting examples of corrosion inhibitors include benzotriazole (BTA), 1,2,3-triazole and 1,2,4-triazole, tetrazole, 5-aminotetrazole, 3-amino-1,2,4-triazole, phenylphosphonic acid, and methylphosphonic acid.

The aqueous carrier can be any aqueous solvent, e.g., water, aqueous methanol, aqueous ethanol, a combination thereof, and the like. Preferably, the aqueous carrier comprises predominately deionized water.

The polishing compositions used in the methods described herein can be prepared by any suitable technique, many of which are known to those skilled in the art. The polishing composition can be prepared in a batch or continuous process. Generally, the polishing composition can be prepared by combining the components thereof in any order. The term “component” as used herein includes individual ingredients (e.g., alumina, acids, chelating agents, buffers, oxidizing agents, and the like), as well as any combination of ingredients. For example, the abrasive can be dispersed in water, combined with the polymer components, and mixed by any method that is capable of incorporating the components into the polishing composition. Typically, an oxidizing agent, when utilized, is not added to the polishing composition until the composition is ready for use in a CMP process, for example, the oxidizing agent can be added just prior to initiation of polishing. The pH can be further adjusted at any suitable time by addition of an acid or base, as needed.

The polishing compositions described herein also can be provided as a concentrate, which is intended to be diluted with an appropriate amount of aqueous solvent (e.g., water) prior to use. In such an embodiment, the polishing composition concentrate can include the various components dispersed or dissolved in aqueous solvent in amounts such that, upon dilution of the concentrate with an appropriate amount of aqueous solvent, each component of the polishing composition will be present in the polishing composition in an amount within the appropriate range for use.

The compositions and methods described herein provide useful platinum and ruthenium removal rates and selectivity for removal of platinum and ruthenium over removal of silicon oxide and silicon nitride. The compositions described herein also can be tailored to provide different rates of platinum removal and different selectivity ratios primarily by utilizing different concentrations of additives and altering the polishing pad and the pH of the compositions. The effects of varying the composition are described in the examples below.

The CMP methods described herein are achieved using a chemical-mechanical polishing apparatus. Typically, the CMP apparatus comprises a platen, which, when in use, is in motion and has a velocity that results from orbital, linear, and/or circular motion, a polishing pad in contact with the platen and moving relative to the platen when in motion, and a carrier that holds a substrate to be polished by contacting and moving relative to the surface of the polishing pad. The polishing of the substrate takes place by the substrate being placed in contact with the polishing pad and a polishing composition described herein and then moving the polishing pad relative to the substrate, so as to abrade at least a portion of the substrate to polish the substrate.

In some embodiments, the platinum removal rate is about 200 Angstroms-per-minute (Å/min) or greater when polishing a wafer, respectively, on a table-top CMP polisher at a down force of about 1.8 pounds-per-square inch (psi), a platen speed of about 120 revolutions-per-minute (rpm), a carrier speed of about 114 rpm, and a polishing slurry flow rate of about 112 milliliters-per-minute (mL/min) with a POLITEX polishing pad. The silicon oxide removal rates typically range from about 50 Å/min to 150 Å/min under the same conditions. Consequently, certain methods described herein provide for selective removal of Pt relative to silicon oxide.

In some embodiments, the methods described herein advantageously remove platinum and ruthenium using a relatively soft polishing pad such as a POLITEX pad or an EPIC D200 pad, as described above and a composition containing as little as 500 ppm of alumina abrasive. The low solid concentration in the composition used in the methods described herein reduce defects such as scratches on the surface of the platinum-containing and ruthenium-containing substrates being polished. The low solid concentration also increases selectivity over silicon nitride and silicon oxide.

The following examples further illustrate certain aspects and features of the compositions and methods described herein but, of course, should not be construed as in any way limiting its scope. As used herein and in the following examples and claims, concentrations reported as parts-per-million (ppm) or percentage (%) are based on the weight of the active component of interest divided by the weight of the composition (e.g., as milligrams of component per kilogram of composition). Removal rates (abbreviated as RR) as used in the following examples and claims represent the rate of removal in angstroms per minute (Å/min).

### Example 1

This example illustrates the effect of alumina concentration on removal of platinum and silicon oxide (TEOS).

Polishing compositions were used to separately chemically-mechanically polish silicon oxide (TEOS) and platinum blanket wafers under the following polishing conditions: bench-top polisher with an embossed POLITEX polishing pad, platen speed of about 120 rpm, carrier speed of about 114 rpm, down pressure of about 1.8 psi, and a slurry flow rate of about 112 mL/minute. In the tests, 1.6 inch by 1.6 inch square wafers having a 3000 Å thickness were cut from a standard 200 mm Pt wafer and 1.6 inch by 1.6 inch square wafers having a 15000 Å thickness were cut from a standard 200 mm TEOS wafer.

Each of the polishing compositions comprised an aqueous slurry of alumina and sucrose of varying concentrations in deionized water. Pt removal rate was evaluated on an OMNIMAP RS75 (KLA Tencor) four point probe. TEOS removal rate was evaluated on a FILMETRICS F20 measurement device. The formulations of the CMP compositions, pH, and corresponding platinum and TEOS removal rates are shown in Table 1, in which “Alumina” refers to alpha alumina having an average particle size of about 90 nm to 100 nm.

TABLE 1

| Example | Alumina | Sucrose | pH | Pt RR | TEOS RR |
|---|---|---|---|---|---|
| 1A | 1% | 0.05% | 6 | 474 | 172 |
| 1B | 0.5% | 0.1% | 6 | 293 | 49 |
| 1C | 0.25% | 0.1% | 6 | 225 | 39 |
| 1D | 0.1% | 0.1% | 6 | 232 | 35 |
| 1E | 0.05% | 0.1% | 6 | 264 | 33 |
| 1F (control) | 0% | 0.1% | 7.2 | 4 | 1 |

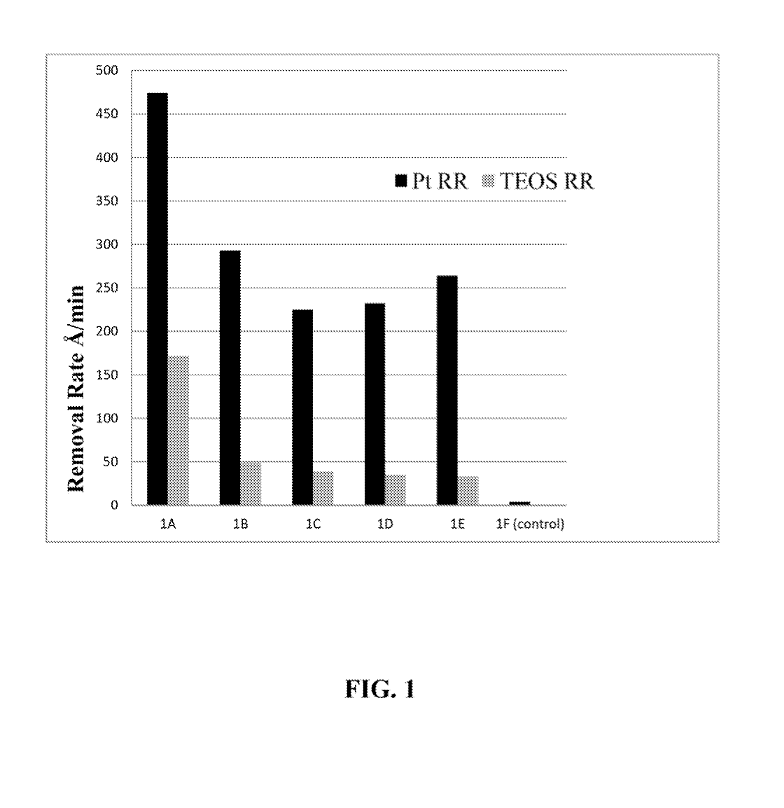

The observed polishing results, i.e., removal rates (RR) for platinum (Pt), and silicon oxide (TEOS) also are shown in FIG. 1.

The results shown in Table 1 and FIG. 1 demonstrate that alumina concentrations as low as 0.05% provided a favorable Pt:TEOS selectivity of greater than 6:1, and an acceptable Pt removal rate of greater than 200 Å/min. Compositions having an alumina concentration of 1% provided a fairly high Pt removal rate of >450 Å/min. Surprisingly, selectivity for Pt over TEOS generally increases as the amount of alumina in the composition decreases from 0.5% to 0.05%.

### Example 2

This example illustrates further effect of sucrose concentration on removal of platinum and silicon oxide (TEOS).

The platinum and TEOS removal rates for various compositions were evaluated using the general polishing conditions of Example 1. Each of polishing compositions 2A, 2B, and 2C comprised an aqueous slurry of 0.5% alumina and 3% hydrogen peroxide in deionized water at a pH of between about 6 and about 6.6. The sucrose concentrations, pH, and corresponding removal rates are shown in Table 2.

TABLE 2

| Example | Sucrose | pH | PT RR | TEOS RR |
|---|---|---|---|---|
| 2A | 0.1% | 6 | 293 | 49 |
| 2B | 0.3% | 6.6 | 412 | 135 |
| 2C | 0.3% | 6 | 293 | 87 |

The results in Table 2 demonstrate that increasing the sucrose concentration generally increases the TEOS removal rate, but decreases the Pt:TEOS selectivity ratio. The increase of sucrose concentration from 0.1% to 0.3% had no effect on the Pt removal rate. Increasing the pH of the composition from pH 6 to pH 6.6 generally increases the Pt and TEOS removal rate. Consequently, the removal rates and selectivity ratios can be tailored by varying the sugar (e.g., sucrose) concentration of the compositions.

### Example 3

This example illustrates the effect of hydrogen peroxide concentration on removal of platinum, silicon oxide (TEOS) and silicon nitride (SiN).

Platinum, TEOS and silicon nitride removal rates were evaluated for various compositions comprising varying amounts of hydrogen peroxide using the general polishing conditions of Example 1. The TEOS and Pt wafers were prepared and analyzed in the same manner as Example 1. In particular, a 1.6 inch by 1.6 inch square wafer having a 3000 Å thickness was cut from a standard 200 mm nitride wafer and used for tabletop polishing in this example. Nitride removal rate was evaluated on a FILMETRICS F20 measurement device.

Each of the polishing compositions comprised an aqueous slurry of 0.1% alumina, 0.1% sucrose, and 0.01% tetramethylammonium acetate (TMAA) in deionized water at a pH of about 6. The hydrogen peroxide concentration was varied as shown in Table 3, along with the corresponding removal rates.

TABLE 3

| Example | H₂O₂ | Pt RR | TEOS RR | SiN RR |
|---|---|---|---|---|
| 3A | 1% | 142 | 20 | 40 |
| 3B | 2% | 209 | 27 | 37 |
| 3C | 3% | 222 | 22 | 29 |

The results in Table 3 demonstrate that increasing the hydrogen peroxide concentration generally increases the Pt removal rate, but not the TEOS or SiN removal rate. The effect of increasing the Pt removal rate without increasing the TEOS or SiN removal rate results in the Pt selectivity increasing over TEOS and SiN as the concentration of hydrogen peroxide increases.

### Example 4

This example illustrates further effects of hydrogen peroxide concentration and sucrose concentration on removal of platinum, silicon oxide (TEOS) and silicon nitride (SiN).

Platinum, TEOS, and silicon nitride removal rates were evaluated for various compositions using the general polishing conditions of Example 1. Each of the polishing compositions comprised an aqueous alumina slurry containing sucrose and hydrogen peroxide in deionized water at a pH of about 6. The formulations of the compositions and corresponding removal rates are shown in Table 4.

TABLE 4

| Example | Alumina | Sucrose | H₂O₂ | Pt RR | TEOS RR | SiN RR |
|---|---|---|---|---|---|---|
| 4A | 0.1% | 0.1% | 3% | 205 | 33 | 33 |
| 4B | 0.1% | 0 | 3% | 274 | 40 | 42 |
| 4C | 0.05% | 0.1% | 3% | 264 | 30 | 60 |
| 4D | 0.05% | 0.1% | 0 | 65 | 6 | 92 |
| 4E | 0.05% | 0 | 3% | 201 | 18 | 28 |

All of the compositions of this Example exhibited a selectivity for Pt removal relative to silicon nitride and silicon oxide in the presence of hydrogen peroxide as the oxidizing agent.

### Example 5

This example explores the effect of pH generally on Pt and TEOS removal rates. The compositions of this Example were used to evaluate the intrinsic effect of pH on Pt and TEOS removal rates without regard to the presence or absence of polishing aids or additives. The results in Table 5 illustrate the general effect of pH on removal of platinum and silicon oxide (TEOS) using an alumina slurry.

Each of the polishing compositions used in this Example 5 comprised an aqueous slurry of 1% alumina and 1% hydrogen peroxide in deionized water at a pH of between about 4 and 7.5. The pH of the CMP compositions and corresponding removal rates are shown in Table 5.

TABLE 5

| Example | pH | Pt RR | TEOS RR |
|---|---|---|---|
| 5A | 4.2 | 52 | 25 |
| 5B | 6.1 | 298 | 77 |
| 5C | 7.5 | 451 | 284 |

The results in Table 5 demonstrate that increasing the pH generally increased the Pt and TEOS removal rate. The TEOS removal rate increases at a different rate than the Pt removal rate as pH increases, and therefore the Pt:TEOS removal selectivity does not increase linearly as a function of pH increase. As shown in Table 5, for a composition having a 1% alumina concentration, the Pt:TEOS selectivity ratio peaked at about pH 6 compared to pH 4 or pH 7.5.

### Example 6

This example illustrates the effect of polishing pad characteristics on removal of platinum, silicon oxide (TEOS) and silicon nitride (SiN).

Using the general polishing conditions of Example 1, the platinum, TEOS and silicon nitride removal rates and selectivity ratios obtained from various compositions were evaluated. In some cases, the polishing conditions were altered by utilizing a harder, D100 pad in place of the POLITEX pad. Each of the polishing compositions comprised an aqueous alumina slurry having 3% hydrogen peroxide, 0.02% bis(2-hydroxyethyl)amino-tris(hydroxymethyl)methane, and 15 ppm NEOLONE in deionized water at a pH of about 6. The concentration of alumina, the polishing pad, and the corresponding removal rates are shown in Table 6, in which “POLITEX” refers to an embossed POLITEX pad, “D100” refers to an EPIC D100 polishing pad, and “D200 42D” refers to an EPIC D200 polishing pad having a Shore D hardness of 42. Prior to polishing, the POLITEX pad was conditioned with a POLITEX conditioning disc, the D100 pad was treated with a 3M A3700 conditioning disc, and the D200 pad was treated with a 3M brand A153L conditioning disc.

TABLE 6

| Example | Alumina | Pad | Pt RR | TEOS RR | SiN RR |
|---|---|---|---|---|---|
| 6A | 0.1% | POLITEX | 203 | 36 | 29 |
| 6B | 0.5% | POLITEX | 414 | 88 | 63 |
| 6C | 0.1% | D100 | 202 | 148 | 82 |
| 6D | 0.5% | D100 | 461 | 110 | 45 |
| 6E | 0.1% | D200 42D | 260 | 96 | 77 |
| 6F | 0.5% | D200 42D | 450 | 55 | 32 |

The results in Table 6 demonstrate that the removal rate ratio for removal of Pt in relation to TEOS increased as the alumina concentration increased when D100 and D200 polishing pads are used. Surprisingly, the Pt:TEOS removal rate ratio decreased as the alumina concentration increased when the POLITEX pad was used. Similar results were observed for the selectivity for removal of Pt in relation to SiN. Specifically, the selectivity for removal of Pt relative SiN increased as alumina concentration increased when D100 and D200 polishing pads are used, but unexpectedly decreased as alumina concentration increases when the POLITEX pad was used. Although the removal rate ratio exhibits these unexpected characteristics, the removal rate of Pt is at all times greater than the removal rate of TEOS and the removal rate of SiN over the full range of compositions and polishing pads used in this example.

### Example 7

This example illustrates further effects of alumina concentration on removal of platinum, ruthenium, and silicon oxide (TEOS).

Platinum, ruthenium, and TEOS removal rates were evaluated for various compositions using the general polishing conditions of Example 1, but modified by replacing the POLITEX pad with a D100 pad, and using a 2.1 psi down pressure. Ruthenium removal rate was evaluated on an OMNIMAP RS75 (KLA Tencor) four point probe.

Each of the polishing compositions comprised an aqueous slurry of alumina, 0.75% ammonium acetate, and 3% hydrogen peroxide in deionized water at a pH of about 6.5. The alumina concentration for each composition, and the corresponding removal rates are shown in Table 7.

TABLE 7

| Example | Alumina | Pt RR | Ru RR | TEOS RR |
|---|---|---|---|---|
| 7A | 1% | 453 | 495 | 481 |
| 7B | 0.5% | 384 | 340 | 519 |
| 7C | 0.25% | 389 | 252 | 530 |

The results in Table 7 unexpectedly demonstrate selectivity differences for removal of Ru in relation to Pt as the alumina concentration was varied. Specifically, the Ru removal rate was greater than the Pt removal rate at a 1% alumina concentration, whereas the Ru removal rate was lower than the Pt removal rate at alumina concentrations of 0.5% and 0.25%. The selectivity for removal of Ru in relation to TEOS showed similar unexpected results. Specifically, the Ru removal rate was greater than the TEOS removal rate at a 1% alumina concentration, whereas the Ru removal rate was lower than the TEOS removal rate at alumina concentrations of 0.5% and 0.25%.

### Example 8

This example illustrates effects of tertiary amines and ammonium salts on removal of platinum, and silicon oxide (TEOS) with alumina polishing slurries.

The platinum and TEOS removal rates for various compositions containing tertiary amines were evaluated using the general polishing conditions of Example 1 (including the use of the POLITEX pad). Each of the polishing compositions comprised an aqueous slurry of 0.1% alumina and 3% hydrogen peroxide in deionized water at a pH of about 6. The additive, additive concentration and corresponding removal rates are shown in Table 8.

TABLE 8

| Example | Additive | Additive Conc. | Pt RR | TEOS RR |
|---|---|---|---|---|
| 8A | triethylamine | 56 ppm | 152 | 25 |
| 8B | tetramethylammonium | 13 ppm | 129 | 31 |
| | nitrate | | | |
| 8C | triethanolamine | 142 ppm | 188 | 38 |
| 8D | ammonium nitrate | 76 ppm | 130 | 24 |

The results in Table 8 show demonstrated high selectivity for Pt removal relative to TEOS over the full range of additives used in this Example.

### Example 9

This example illustrates the effect of pH and additional additives on removal of platinum, ruthenium, and silicon oxide (TEOS).

Platinum, ruthenium, and TEOS removal rates were evaluated for various compositions using the general polishing conditions of Example 7 (D100 pad at a 2.1 psi down pressure). Each of the polishing compositions comprised an aqueous slurry of 1% alumina and 3% hydrogen peroxide in deionized water. The additive identity, additive concentrations, and the pH of the CMP compositions and corresponding removal rates are shown in Table 9, in which “PA” refers to potassium acetate and “AN” refers to ammonium nitrate.

TABLE 9

| Example | Additive | pH | Pt RR | Ru RR | TEOS RR |
|---|---|---|---|---|---|
| 9A | 0.75% PA | 6.5 | 649 | 498 | 1046 |
| 9B | 0.75% PA | 5.7 | 497 | 501 | 699 |
| 9C | 0.75% PA | 5.5 | 467 | 606 | 544 |
| 9D | 0.75% AN | 6.5 | 318 | 277 | 503 |
| 9E | 0.75% AN | 5.7 | 311 | 393 | 498 |

The results in Table 9 demonstrate that the selectivity for removal of Ru in relation to Pt differed based on the pH of the compositions. Specifically, the Ru removal rate was greater than the Pt removal rate at pH 6.5, whereas the Ru removal rate was lower than the Pt removal rate at pH 5.7 and 5.5. The TEOS removal rate was greater than both the Pt removal rate and the Ru removal rate for all pH values other than pH 5.5. At pH 5.5, the TEOS removal rate was unexpectedly less than the Ru removal rate. The removal rates for all of the layers (Pt, Ru and TEOS) under the conditions of Example 9 were much higher than the removal rates obtained under the conditions of Example 8.

### Example 10

This example illustrates the effect of pH and additional additives on removal of platinum, ruthenium, and silicon oxide (TEOS).

Using the general polishing conditions of Example 7 (a D100 pad and a 3M A3700 conditioner at a 2.1 psi down pressure), the platinum, ruthenium, and TEOS removal rates obtained from various compositions were evaluated. Each of the polishing compositions comprised an aqueous slurry of 1% alumina, 0.75% ammonium acetate and 3% hydrogen peroxide in deionized water. The additive, additive concentrations, and corresponding removal rates obtained with each composition are shown in Table 10. The abbreviation “bis-tris” in the Table 10 means bis(2-hydroxyethyl)amino-tris(hydroxymethyl)methane.

TABLE 10

| Example | Additive | pH | Pt RR | Ru RR | TEOS RR |
|---|---|---|---|---|---|
| 10A | 0.04% bis-tris | 6.5 | 257 | 359 | 736 |
| 10B | 0.04% bis-tris | 5.7 | 301 | 228 | 815 |
| 10C | 0.1% sucrose | 6.5 | 354 | 418 | 870 |
| 10D | 0.1% sucrose | 5.7 | 481 | 305 | 753 |
| 10E | 0.01% dextrin | 6.5 | 228 | 464 | 986 |
| 10F | 0.01% dextrin | 5.7 | 284 | 349 | 768 |

The conditions of Example 10 also produced unexpected results, i.e., the TEOS removal rate was generally at least about two times the Ru removal rate and about 1.5 to 4 times the Pt removal rate. Surprisingly, the selectivity for removal of TEOS versus Pt was greater at pH 6.5 than at pH 5.7, whereas selectivity for removal of TEOS versus Ru was greater at pH 5.7 than at pH 6.5.

Collectively, the results presented herein demonstrate that the relative removal rates for Pt, Ru, TEOS, and Silicon nitride advantageously can be varied and tailored based on the choice of polishing additives, the concentration of the additives, the pH, and the alumina concentration.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A chemical-mechanical polishing (CMP) method for polishing a substrate comprising platinum, ruthenium or a combination thereof, the method comprising contacting a substrate with a surface of a polishing pad in the presence of an oxidizing agent and an aqueous polishing composition between the pad and the substrate;
wherein the polishing composition has a pH in the range of about 4 to about 8 and comprises an aqueous carrier containing a particulate alumina abrasive and at least one additive selected from the group consisting of an suppressor, a complexing agent, and an amino compound.

2. The method of claim 1 wherein the amino compound comprises at least one compound selected from the group consisting of ammonia, an organic amine, an organic ammonium compound or a salt thereof.

3. The method of claim 2 wherein the oxidizing agent comprises hydrogen peroxide.

4. The method of claim 2 wherein the oxidizing agent is present in the composition at a concentration in the range of about 0.1 to about 10 percent by weight (wt %).

5. The method of claim 1 wherein the suppressor comprises a water-soluble carbohydrate.

6. The method of claim 5 wherein the water-soluble carbohydrate comprises sucrose.

7. The method of claim 1 wherein the complexing agent comprises an alkanolamine.

8. The method of claim 7 wherein the alkanolamine comprises bis(2-hydroxyethyl)amino-tris(hydroxymethyl)methane.

9. The method of claim 2 wherein the amino compound comprises a quaternary ammonium salt.

10. The method of claim 9 wherein the quaternary ammonium salt comprises a tetramethylammonium salt.

11. The method of claim 2 wherein the amino compound comprises ammonium acetate.

12. The method of claim 2 wherein the amino compound comprises a tertiary amine.

13. The method of claim 1 wherein the complexing agent comprises a carboxylate salt.

14. The method of claim 13 wherein the carboxylate salt is present in the composition at a concentration in the range of about 0.01 to about 1.5 percent by weight (wt %).

15. The method of claim 1 wherein the alumina is present in the composition at a concentration in the range of about 0.001 to about 10 percent by weight (wt %).

16. The method of claim 1 wherein the alumina has an average particle size in the range of about 50 to about 1000 nm.

17. The method of claim 1 wherein the surface of the polishing pad contacting the substrate has a hardness of not more than about 80 Shore D.

18. The method of claim 1 wherein the surface of the polishing pad contacting the substrate comprises a porous polymer.

19. The method of claim 18 wherein the surface of the polishing pad contacting the substrate comprises a non-woven porous polyurethane having a hardness in the range of about 15 to 80 Shore D.

20. The method of claim 18 wherein the surface of the polishing pad contacting the substrate comprises a non-woven porous polymer having a percentage open pore volume in the range of about 10 to 80%.

21. The method of claim 1 wherein the surface of the polishing pad contacting the substrate has a hardness in the range of about 15 to about 50 Shore D.

22. The method of claim 1 wherein the additive is present in the composition at a concentration in the range of about 0.001 to about 5 percent by weight (wt %).

23. A chemical-mechanical polishing (CMP) method for polishing a substrate comprising platinum, ruthenium or a combination thereof, the method comprising contacting the substrate with a surface of a polishing pad in the presence of an oxidizing agent and an aqueous polishing composition between the pad and the surface of the substrate;
wherein the surface of the polishing pad contacting the substrate comprises a porous polymer having a hardness of not more than about 80 Shore D, the polishing composition has a pH in the range of about 5 to about 7, and the composition comprises an aqueous carrier comprising:
(a) about 0.001 to about 10 percent by weight (wt %) of a particulate alumina abrasive having an average particle size in the range of about 10 to about 1000 nm;
(b) optionally, about 0.1 to about 10 wt % of hydrogen peroxide;
(c) a suppressor;
(d) a complexing agent; and
(e) an amino compound.

24. An aqueous polishing composition suitable for polishing a platinum-containing or ruthenium-containing surface, the polishing composition having a pH of about 4 to about 8 and comprising an aqueous carrier containing about 0.001 to about 10 wt % of a particulate alumina abrasive and about 0.001 to about 5 percent by weight of at least one additive selected from the group consisting of a suppressor, a complexing agent, and an amino compound.

25. The composition of claim 25 further comprising about 0.1 to about 10 percent by weight (wt %) of hydrogen peroxide.
